(19) United States
(12) Patent Application Publication
(10) Pub. No.: US 2026/0180879 A1
(43) Pub. Date: Jun. 25, 2026

(54) DEEP PACKET INSPECTION ON NETWORK DEVICES

(71) Applicant: HEWLETT PACKARD ENTERPRISE DEVELOPMENT LP, Spring, TX (US)

(72) Inventors: Venkata Varadhan Devarajan, Bangalore (IN); Saurabh Mohan, Roseville, CA (US); Sandip Bidaye, Roseville, CA (US)

(21) Appl. No.: 19/068,930

(22) Filed: Mar. 3, 2025

(30) Foreign Application Priority Data
Dec. 19, 2024 (IN) 202441100928

(51) Int. Cl. H04L 43/028

(52) U.S. Cl. CPC H04L 43/028

(57) ABSTRACT

Load balancing operations between network devices to perform DPI operations are provided herein. Network devices of a virtualized network device arrangement may load balance network traffic by employing a network link between the network devices to exchange data packets for DPI operations. Further, the network devices may employ dedicated CPUs to offload DPI operations. In this manner, the current techniques may enable preservation of pre-existing networking routing or deterministic routing to be performed on-the-fly by enabling DPI to be performed without constraining network traffic flows to a specified route.

### BACKGROUND

The present disclosure relates generally to techniques for performing deep packet inspection. More specifically, the present disclosure relates to techniques that enable network devices (e.g., network switches) to load balance network traffic while performing deep packet inspection (DPI).

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A system may include network devices to enable network traffic to be sent between a source device and an endpoint device. Certain processing operations may be performed by such network devices when routing packets, such as bandwidth management operations, security operations, load balancing, and DPI. For example, the network device may employ an engine to perform deep packet inspection to analyze contents of the traffic while also load balancing the traffic. Although load balancing may enable a network to be more efficient overall in its resource consumption, DPI may use packets from both directions of the traffic (e.g., from an endpoint device and to the endpoint device). Forcing the flow of traffic through the network device may undermine the benefits from the load balancing.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagram, illustrating a system that includes a first data forwarder with a first deep packet inspection (DPI) engine and a second data forwarder with a second DPI engine, in accordance with aspects of the present disclosure;

FIG. 2 is a diagram, illustrating the system of FIG. 1 routing one or more data packets at a first time, a second time, and a third time, in accordance with aspects of the present disclosure;

FIG. 3 is a diagram, illustrating a first data packet flow and a second data packet flow within the system of FIG. 1, in accordance with aspects of the present disclosure;

FIG. 4 is a flowchart, illustrating a process for steering a copy of a data packet to a target DPI engine, in accordance with aspects of the present disclosure;

FIG. 5 is a flowchart, illustrating a process for steering a copy of a data packet between data forwarders for DPI, in accordance with aspects of the present disclosure;

FIG. 6 is a flowchart, illustrating the process of FIG. 4 including a process for ceasing steering a copy of the data packet based on the target DPI engine becoming unavailable, in accordance with aspects of the present disclosure; and

FIG. 7 is a diagram, illustrating a computer-readable medium storing computer-readable instructions for DPI steering, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

A system may use a network device (e.g., network switch, data forwarder, network component) to perform deep packet inspection (DPI) on network traffic (e.g., data packets) received at or transmitted from the network device on a communication network. A DPI engine associated with the network device may perform DPI based on receipt of a flow of traffic in both directions. At times, the network traffic from a client device may flow via a first network device to a server and response traffic from the server may flow via a second network device to the client device, causing DPI to not be able to be performed.

To enable DPI, flow anchoring (e.g., session anchoring) may be used. Flow anchoring may force a flow of network traffic through a specific network device or a specific combination of network devices to enable DPI on both directions of the flow. However, employing flow anchoring may be time-consuming and increase computing resource usage because the system may bypass advantages from employing an infrastructure that supports traffic forwarding asymmetry and load balancing.

Accordingly, the present disclosure relates generally to techniques that enable virtualized (e.g., Virtualization Switching Extensions (VSX)) network device arrangements to freely load balance network traffic while performing DPI. For example, the virtualized network device arrangements may include multiple network devices that operate as a single network device and/or that may enable active-standby configurations (e.g., a network device performs a task while other network devices are idle). More specifically, the present disclosure relates to routing network packet flows between electronic devices deterministically between the virtualized network device arrangements to provide load balancing. Indeed, network devices of the virtualized network device arrangements may load balance the network traffic. By employing a network link (e.g., private tunnel, inter-switch link) between the network devices, the network devices may exchange data packets and perform DPI, all while preserving networking routing or deterministic network routing operations, so that DPI may occur without constraining network traffic flows to a specified route.

To elaborate, a system may include, as the network devices, one or more network switches, such as a first network switch and a second network switch. It should be noted that the techniques described herein with respect to the first network switch are merely exemplary and the same techniques described herein may be performed by the second network switch or any other suitable network switch included in the system. The first network switch may be coupled to the second network switch via a network link (e.g., private tunnel enabled via a communication link) to enable a virtualized (e.g., VSX) switch pair. The virtualized switch pair may be presented as a network switch cluster (e.g., single virtual switch). Moreover, the network link may be used to transmit copied packets from the network traffic flow to enable DPI.

For example, the first network switch may determine that DPI is to be performed and may generate a copy of the data packet. The first network switch may determine whether to send the data packet copy to a remote DPI engine (via the network link) or to a local DPI engine based on one or more steering characteristics (e.g., one or more DPI steering characteristics). The first network switch may determine a steering characteristic based on a symmetrical hash, a policy look-up table function, or any other suitable load-distribution mechanism.

In some systems, the network device may lack computing resources to support the DPI engine. Thus, the system may employ offloaded DPI engines at network devices (e.g., network switches) positioned at an aggregation layer of a network. For example, the network devices may use dedicated central processing unit (CPU) (e.g., on its associated local CPU or a remote CPU of a separate network device) that includes a respective DPI engine, to perform DPI.

Respective steering engines may perform complementary routing to enable both directions of network traffic to arrive at the same, targeted DPI engine for DPI. In this manner, the system may enable DPI operations without constraining a routing within the network device arrangements, which may increase availability of computing resources and efficiency of the system.

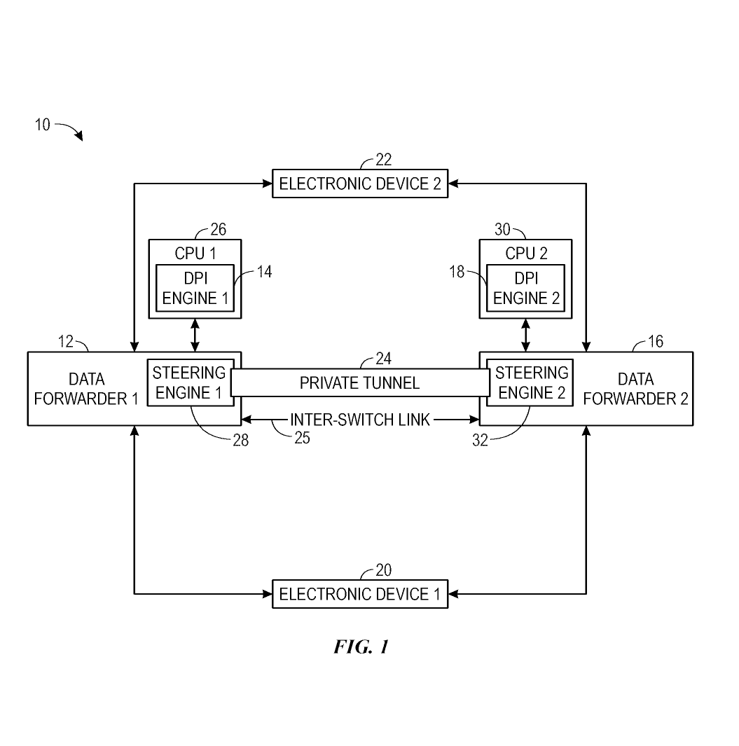

With this in mind, FIG. 1 is a diagram, illustrating a system 10 that includes a first data forwarder 12 with a first DPI engine 14 and a second data forwarder 16 with a second DPI engine 18, in accordance with aspects of the present disclosure. The first data forwarder 12 and the second data forwarder 16 may receive and route (e.g., direct or select a path for)network traffic, such as data packets, between a first electronic device 20 and a second electronic device 22. For example, the first data forwarder 12 and the second data forwarder 16 may include or correspond to any suitable network device or network component, such as network switches. Moreover, it should be noted that while the first data forwarder 12 and the second data forwarder 16 are illustrated in FIG. 1, the system 10 may include any suitable number of data forwarders with respective DPI engines to perform the techniques described herein.

One or more devices (e.g., the first data forwarder 12, the second data forwarder 16, the first electronic device 20, the second electronic device 22) illustrated in the system 10 may include or be any suitable computing devices that may utilize data storage and/or memory. Such computing devices may include servers, desktop computers, laptop computers, tablet computers, cellular devices, wearable devices, and/or other computing devices. The first CPU 26 and/or the second CPU 30 may be disposed in dedicated computing devices (not depicted) and thus may have access to storage/memory separate from storage/memory of the one or more devices. In some cases, the CPUs (e.g., first CPU 26, second CPU 30) are included in the data forwarders (e.g., first CPU 26 in first data forwarder 12, second CPU 30 in second data forwarder 16) to expand a processing capability of that respective data forwarder, and thus may access storage/memory of that respective data forwarder. The storage/memory may include any suitable articles of manufacture suitable for storing data and/or executable instructions. For example, the storage/memory may include instructions that, when executed by processing circuitry of the first CPU 26 enable performance of DPI. The storage/memory may include a storage device, such as a Non-Volatile Memory Express (NVMe) device, a hard disk drive (HDD), a solid-state drive (SSD), an optical drive, another type of storage device, flash memory, read-only memory (ROM), or any combination thereof. The storage/memory includes memory that may include any suitable memory devices, such as a double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof.

The first data forwarder 12 and the second data forwarder 16 may be coupled through a private tunnel 24. For example, the private tunnel 24 may operate based on a communication link 25 (e.g., inter-switch link). The communication link 25 may be a hardware-based physical or wireless communicative coupling between one or more data forwarders that enable mutual communicative exchanges of data between the one or more data forwarders. For example, data received via the communication link 25 may bypass one or more security validation operations, or other processing operations, to enable more efficient mutual communication between respective data forwarders that consumes fewer computing resources and/or experiences reduced amounts of latency in such communication. The private tunnel 24 operating based on the communication link 25 may correspond to a higher computing level than a physical layer (e.g., Layer 1 of a Open System Interconnection (OSI) model or other similar networking communication model) that the communication link 25 may be associated with. For example, the private tunnel 24 may correspond to communication operations that occur at a data link layer (e.g., Layer 2 of the OSI model) and/or at a network layer (e.g., Layer 3 of the OSI model). Communications via the private tunnel 24 may involve processing and data packaging operations that occur at a layer above the physical layer.

As another example, the private tunnel 24 may operate using protocols, such as a Virtual Extensible Local Area Network (VxLAN) or Layer 2 Generic Routing Encapsulation (L2GRE). The VxLAN protocol and the L2GRE protocol may enable encapsulation of network traffic at the data link layer and transportation of the encapsulated network travel over the physical layer. The private tunnel 24 may enable the first data forwarder 12 and the second data forwarder 16 to employ a private Internet Protocol (IP) address space on an internal process (e.g., using computing resources within an environment of the system 10, without involvement of external systems) for packet transportation. Indeed, the first data forwarder 12 and the second data forwarder 16 may employ the private tunnel 24 to transmit copies of data packets to each other for DPI.

Moreover, the private tunnel 24 may enable the first data forwarder 12 and the second data forwarder 16 to operate as a virtualized pair, e.g., a virtualized (e.g., VSX) switch pair (e.g., network switch cluster). For example, the virtualized pair may include multiple data forwarders that operate as a single data forwarder and/or that may enable active-standby configurations (e.g., a data forwarder performs a task while other data forwarders are idle). In this manner, the first data forwarder 12 and the second data forwarder 16 may operate (e.g., function) as a single virtual forwarder (e.g., single virtual network device) within a virtualized environment. For example, the private tunnel 24 may enable the first data forwarder 12 and the second data forwarder 16 to perform features, such as load balancing, while presenting a unified interface for the first electronic device 20 and the second electronic device 22.

The first data forwarder 12 may be communicatively coupled to a first CPU 26, which includes the first DPI engine 14, and a first steering engine 28. Further, the second data forwarder 16 may be communicatively coupled to a second CPU 30, which includes the second DPI engine 18, and a second steering engine 32. It should be noted that the first DPI engine 14 may be integrated as hardware (e.g., hardware component) or software (e.g., embedded in a software application) in the first data forwarder 12. Additionally, it should be noted the second DPI engine 18 may be integrated as hardware or software in the second data forwarder 16. In some systems, the first data forwarder 12 may include the first CPU 26. In some systems, the second data forwarder 16 may include the second CPU 30. In some systems, the first data forwarder 12 may be separate from the first CPU 26. Therefore, the first data forwarder 12 may couple to the first CPU 26 and enable the first CPU 26 to operate as dedicated processing circuitry for the first data forwarder 12. Further, in some systems, the second data forwarder 16 may be separate from the second CPU 30. Thus, the second data forwarder 16 may couple to the second CPU 30 and enable the second CPU 30 to operate as dedicated processing circuitry for the second data forwarder 16. The first data forwarder 12 may employ the first DPI engine 14 to perform DPI on one or more data packets received at the first data forwarder 12 (e.g., from the first electronic device 20 and/or the second electronic device 22). Moreover, the second data forwarder 16 may employ the second DPI engine 18 to perform DPI on one or more data packets received at the second data forwarder 16 (e.g., from the first electronic device 20 and/or the second electronic device 22). The first CPU 26 and the second CPU 30 may enable offloading of DPI operations from the first data forwarder 12 and the second data forwarder 16, which may desirably enable relatively greater amounts of computing resources to be used by other operations of the first data forwarder 12 and/or the second data forwarder 16. The first CPU 26 and the second CPU 30 may enable the first data forwarder 12 and/or the second data forwarder 16 to offload DPI operations by transferring DPI operations, such as tasks of inspecting and analyzing the one or more data packets, to one another. For example, the first CPU 26 may be coupled to the first data forwarder 12 such that the first CPU 26 performs computing tasks associated with the DPI operations (e.g., inspection, analysis) in response to instructions received from the first data forwarder 12 and/or in response to receiving the one or more data packets from the first data forwarder 12 or the second data forwarder 16 independent of instructions from that respective data forwarder (e.g., the first CPU 26 may be programmed to perform DPI, via DPI engine, automatically in response to receiving one or more copies of data packets from either data forwarders without further enable instructions). The second CPU 30 may provide similar offloading and DPI initiation as described in the example relative the first CPU 26.

As an example, the first data forwarder 12 and/or the second data forwarder 16 may determine that DPI is to be performed based on characteristic data, such as a flow-miss (e.g., a data packet received does not match an existing entry) in a flow-table lookup and/or a flow attribute of the data packet indicating that DPI is ongoing. The first DPI engine 14 and/or the second DPI engine 18 may perform DPI based on receipt of a flow of traffic in both directions (e.g., a flow from the first electronic device 20 to the second electronic device 22 and a flow from the second electronic device 22 to the first electronic device 20).

Thus, the first data forwarder 12 may employ the first steering engine 28 and/or the second data forwarder 16 may employ the second steering engine 32 to enable receipt of the flow of traffic in both directions. For example, the first steering engine 28 may include software executed by the first data forwarder 12 to identify (e.g., determine) a target DPI engine (e.g., the first DPI engine 14 or the second DPI engine 18) for DPI of the received data packets. Further, the second steering engine 32 may include software executed by the second data forwarder 16 to identify the target DPI engine for the received data packets.

As an example, the first data forwarder 12 and the second data forwarder 16 may store indications of one or more policies, one or more pre-defined rules, and/or real-time data analysis. The indications may provide instructions on what action for the first data forwarder 12 and the second data forwarder 16 to take based on a set of conditions. Indeed, for example, the first data forwarder 12 and the second data forwarder 16 may include a policy, which may be a set of rules (e.g., defined rules) or guidelines that define how the first data forwarder 12 and the second data forwarder 16 may operate and/or perform certain behaviors for steering data packets. For example, the first steering engine 28 and/or the second steering engine 32 may access an indication of the policy and operate pursuant to the indication to steer copies of the data packets to target DPI engines.

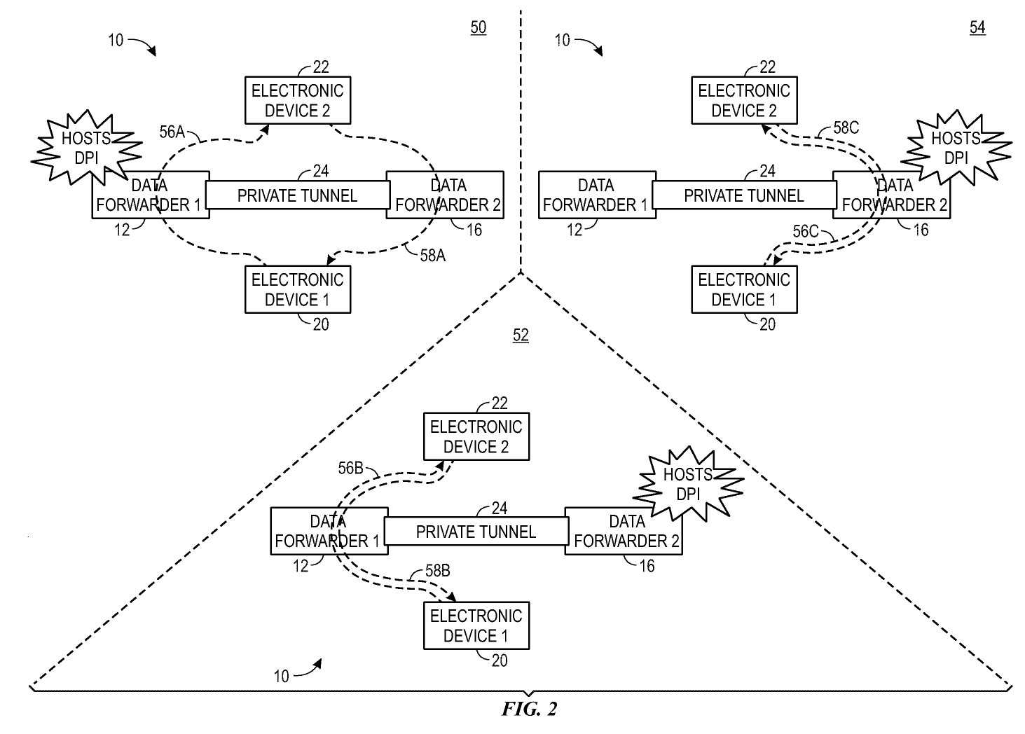

The first steering engine 28 and the second steering engine 32 may identify the target DPI engine based on symmetric hashing, a policy table look-up function, or another suitable load-distribution mechanism. In this manner, the first data forwarder 12 may determine whether to transmit a copy of the one or more data packets received to the first CPU 26 (e.g., its coupled local CPU) with the first DPI engine 14 to perform DPI. Alternatively, the first data forwarder 12 may determine whether to transmit the copy of the one or more data packets to the second CPU 30 with the second DPI engine 18 (e.g., remote CPU) via the private tunnel 24 to perform DPI. It should be noted that the second data forwarder 16 or any other suitable data forwarder included in the system 10 may perform the operations described herein with respect to the first data forwarder 12. Additional details regarding identifying the target DPI engine will be described below with respect to FIGS. 2-4.

Indeed, as will be described in further detail below, the first data forwarder 12 and the second data forwarder 16 may transmit copies of respective data packets via the private tunnel 24 to enable DPI. Indeed, the first data forwarder 12 may transmit the one or more data packets received to the second data forwarder 16 via the private tunnel 24 for DPI. The second data forwarder 16 may also transmit the one or more data packets received to the first data forwarder 12 via the private tunnel 24 for DPI. As such, the first data forwarder 12 and the second data forwarder 16 may employ the private tunnel 24 to deterministically route copies of the network traffic for DPI. Further, the first data forwarder 12 and/or the second data forwarder 16 may load balance the network traffic and offload DPI operations to one another to reduce a usage of computing resources and minimize overloading the first CPU 26 and the second CPU 30.

FIG. 2 is a diagram, illustrating the system 10 of FIG. 1 routing network traffic, such as one or more data packets, at a first time 50, a second time 52, and a third time 54, in accordance with aspects of the present disclosure. Indeed, as illustrated in FIG. 2, the system 10 may adjust routing of the one or more data packets between the first electronic device 20 and the second electronic device 22 at different times. The system 10 may do so as part of deterministic network routing, such as load balancing operations that change a routing of network traffic through network components to respond to changes in source device, endpoint device, bandwidth usage, security changes, or the like. Deterministic network routing may be performed on one or both directions of network traffic. When changing the routing of network traffic, the path taken through data forwarders like data forwarders 12 and/or 16 may change over time. By using systems and methods described herein, deterministic network routing that changes the routing of network traffic may be performed without affecting DPI since copies of packets of the network traffic may be routed to the device hosting the DPI regardless of literal path routed through the devices.

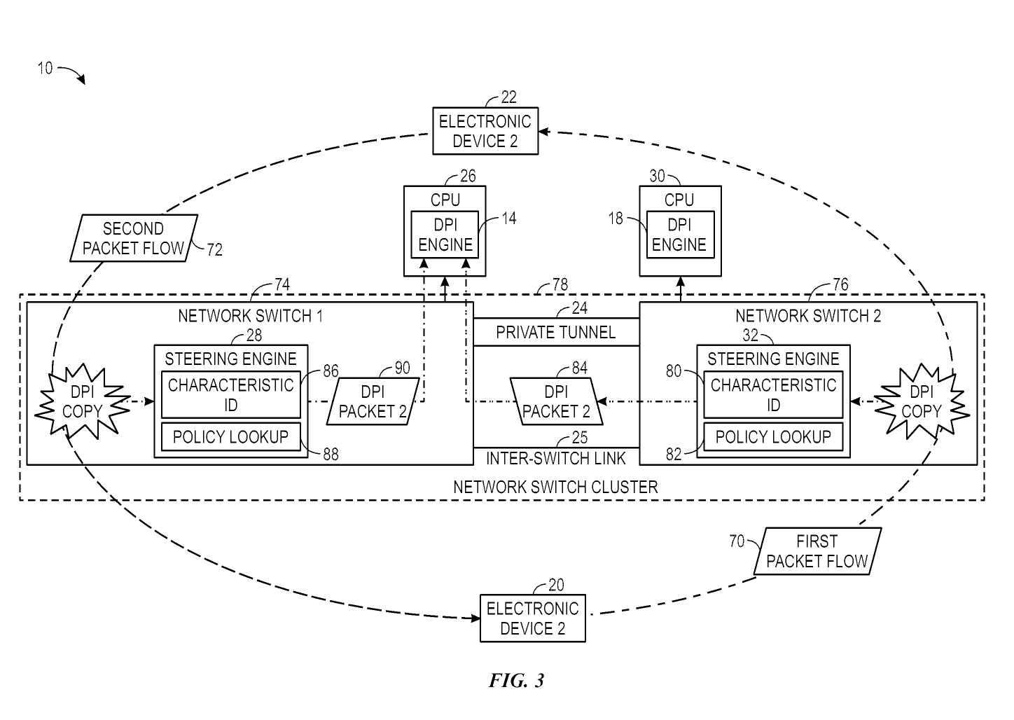

In this illustrated example, data forwarder 16 hosts DPI. That is, the data forwarder 16 either performs the DPI and/or is coupled to a DPI engine that will perform the DPI via provision of a data packet from the data forwarder 16. Systems and methods described herein may cause the data forwarder 16 to be provided copies of both directions of network traffic for DPI. It should be understood that either data forwarder 12 and/or 16 may perform DPI at different times. The data forwarders 12 and 16 may alternate performing DPI on subsequent packets of the network traffic. For example, a first packet may be followed by a second packet then a third packet in respective network traffic. The first data forwarder 12 may perform DPI on the first packet and the third packet, and not the second packet. The second data forwarder 16 may perform DPI on the second packet and not the first and third packets. The steering engines 28 and/or 32 may route the copies of the packets locally or remotely responsive to processing of header data of the packets, as is elaborated on herein with respect to FIG. 3.

For example, at the first time 50, the first electronic device 20 may generate first network traffic (e.g., onward flow, uplink network traffic, client-to-server network traffic) and transmit the first network traffic in a first direction 56a to the first data forwarder 12 for transmission to the second electronic device 22. Additionally, the second electronic device 22 may generate second network traffic (e.g., reverse flow, downlink network traffic, server-to-client network traffic), such as in response to receiving the first network traffic. The second data forwarder 16 may transmit the second network traffic in a second direction 58a to the second data forwarder 16 for transmission to the first electronic device 20. As described herein, first network traffic and second network traffic is used for illustrative purposes and it should be understood that both first and second network traffic may be associated with a same or different communication or exchange.

The first data forwarder 12 may receive the first network traffic and determine that DPI is to be performed on the first network traffic. For example, the first data forwarder 12 may determine DPI is to be performed based on the flow-miss in the flow-table lookup or the flow attribute of the first data packet indicating that DPI is ongoing. As illustrated in FIG. 2, the first data forwarder 12 may host DPI for the first network traffic and the second network traffic. Thus, the second data forwarder 16 may generate a copy of the second network traffic and steer the copy to the first data forwarder 12 for DPI via the private tunnel 24. For example, as will be described in further detail below with respect to FIG. 3, the second data forwarder 16 may identify the first DPI engine 14 of FIG. 1 as the target DPI engine based on determining a steering characteristic of the second network traffic. In this manner, the second data forwarder 16, as the DPI host (e.g., the target DPI engine), may perform DPI on copies of both the first direction 56a of the first network traffic and the second direction 58a of the second network traffic.

Indeed, the DPI host may perform DPI based on receipt copied data of both the first direction 56a of the first network traffic and the second direction 58a of the second network traffic copy. In this manner, the first direction 56a of the first network traffic and the second direction 58a of the second network traffic copies may be transmitted to the same DPI engine of the DPI host. Moreover, a symmetric value associated with the first direction 56a of the first network traffic and the second direction 58b of the second network traffic may be employed to identify either the first data forwarder 12 or the second data forwarder 16 that is assigned to the first network traffic and the second network traffic.

As another example, at the second time 52, the first electronic device 20 may transmit the first network traffic in a first direction 56b to the first data forwarder 12 for transmission to the second electronic device 22. Additionally, the second electronic device 22 may transmit the second network traffic in a second direction 58b to the first data forwarder 12 for transmission to the first electronic device 20 (e.g., in response to receiving the first network traffic). The first data forwarder 12 may receive the first network traffic and the second network traffic and determine DPI is to be performed on the first network traffic and the second network traffic.

At the second time, the second data forwarder 16 may host DPI for the first network traffic and the second network traffic. Thus, the first data forwarder 12 may generate a first copy of the first network traffic and a second copy of the second network traffic. The first data forwarder 12 may steer the first copy and the second copy to the second data forwarder 16 via the private tunnel 24. The second data forwarder 16 may perform DPI on both the first direction 56b of the first copy of the first network traffic and the second direction 58b of the second copy of the second network traffic.

As yet another example, at the third time 54, the first electronic device 20 may transmit the first network traffic in a first direction 56c to the second data forwarder 16 for transmission to the second electronic device 22. Additionally, the second electronic device 22 may transmit the second network traffic in a second direction 58c to the second data forwarder 16 for transmission to the first electronic device 20 (e.g., in response to receiving the first network traffic). The second data forwarder 16 may receive the first network traffic and the second network traffic and determine that DPI is to be performed on the first network traffic and the second network traffic.

As such, the second data forwarder 16 may generate the first copy of the first network traffic and the second copy of the second network traffic. Because the second data forwarder 16 is the host DPI, the second data forwarder 16 may provide the first copy and the second copy to the second DPI engine 18 (e.g., its own associated DPI engine of the second CPU 30) to perform DPI. The second data forwarder 16 may perform DPI based on the first copy of the first direction 56c of the first network traffic and the second copy of the second direction 58c of the second network traffic. It should be noted that the techniques described herein with respect to FIG. 2 are merely exemplary and the same techniques may be performed via any suitable number of data forwarders and various differing routes. For example, the first data forwarder 12 may be the host DPI and receive both directions of copies of the first network traffic and the second network traffic.

With the foregoing in mind, FIG. 3 is a diagram, illustrating a first data packet flow 70 and a second data packet flow 72 within the system 10 of FIG. 1, in accordance with aspects of the present disclosure. As described herein, the system 10 may include any suitable data forwarders (e.g., the first data forwarder 12, the second data forwarder 16) to route data between the first electronic device 20 and the second electronic device 22. For example, the system 10 may include a first network switch 74 and a second network switch 76, which may be presented as a network switch cluster 78 (e.g., single virtual switch). It should be noted that the first network switch 74 and the second network switch 76 may include any suitable components (e.g., software and/or hardware) and functions described herein with respect to the first data forwarder 12 and the second data forwarder 16 of FIG. 1.

Indeed, the first network switch 74 may use the first CPU 26 with the first DPI engine 14 and the first steering engine 28. Additionally, the second network switch 76 may use the second CPU 30 with the second DPI engine 18 and the second steering engine 32. For the first data packet flow 70, the first electronic device 20 may generate a first data packet and transmit the first data packet to the second network switch 76 for transmission to the second electronic device 22. As an example, the first data packet may include a 5-tuple, which includes a source Internet Protocol (IP) address (src.ip) (e.g., of sender), a destination IP address (dst.ip) (e.g., of recipient), a source port (src.I4port), a destination port (dst.I4port), and an IP protocol (ip.protocol) (e.g., type of protocol used for communication). Further, the first data packet structure may include a header (e.g., which may include the 5-tuple) and a payload.

The second network switch 76 may receive the first data packet and determine whether DPI is to be performed on the first data packet. The second network switch 76 may determine DPI is to be performed based on a flow-miss in a flow-table lookup, a traffic type, a policy (e.g., pre-defined software rule or instruction), or analysis of the first data packet flow 70 (e.g., a flow attribute indicates that DPI is ongoing). As an example, the second network switch 76 may check its flow table (e.g., stored at the second network switch 76) to determine if an existing entry in the flow table matches characteristics of the first data packet. For example, the characteristics may include the contents of the packet header (e.g., the 5-tuple) of the first data packet. If the second network switch 76 does not find a matching entry, the second network switch 76 may determine the first data packet flow 70 (e.g., the first data packet) does not belong to an established (e.g., known) flow. Thus, the second network switch 76 may determine that DPI is to be performed on the first data packet (e.g., to enable inspection of the header and the payload of the first data packet). As another example, the traffic type may indicate whether the first data packet is associated with a virtual local area network (VLAN), a port, or a role that has been established (e.g., set) by the system 10 for DPI.

To prevent network traffic flow disruption, the second network switch 76 may generate a copy of the first data packet 84 for DPI. The first data packet flow 70 may ingress through an in-port and egress through an out-port without interruption, which enables the system 10 to maintain network performance and/or deterministic routing from load balancing algorithms. The second network switch 76 may employ the second steering engine 32 to determine a steering characteristic 80 (e.g., DPI steering characteristic) of the first data packet. The steering characteristic may be associated with a target DPI engine (e.g., the first DPI engine 14 or the second DPI engine 18). For example, a first steering characteristic may be associated with the first DPI engine 14 and a second steering characteristic may be associated with the second DPI engine 18. To identify the steering characteristic, the second network switch 76 may employ the second steering engine 32 to determine a symmetrical hash value (e.g., Receive Side Scaling (RSS) symmetrical hash value) associated with the first data packet. As an example, the symmetrical hash value may serve as an index for steering policies indicating which network switch will host DPI for the associated packets.

The second network switch 76 may employ the second steering engine 32 to apply a hash function to contents of the first data packet, such as the packet header (e.g., including the 5-tuple, which includes the source IP address, the destination IP address, the source port, the destination port, and the IP protocol), to derive (e.g., produce, provide) the symmetrical hash value. The symmetrical hash value, being the same for both forward/upstream (e.g., source to destination) and backward/downstream (e.g., destination to source) packet transmissions, may serve as an index for determining DPI policy assignments. For example, the symmetrical hash value may include a mask on a last bit (e.g., last bit value) of the symmetrical hash value. The mask on the last bit of the symmetrical hash value may include 1, which may be associated with the first steering characteristic, or 0, which may be associated with the second steering characteristic. In this manner, the second steering engine 32 may enable the second network switch 76 to identify whether the symmetrical hash value includes the first characteristic or the second characteristic based on the last bit. Moreover, the second steering engine 32 may steer the copy of the first data packet 84 to the first DPI engine 14 or the second DPI engine 18 based on whether the symmetrical hash value includes the first characteristic or the second characteristic. At times, the second steering engine 32 may extract metadata from the first data packet and generate a hash based on the metadata. The second steering engine may determine the steering characteristic based on the hash. When additional steering engines are available, the steering characteristic may be adjusted. For example, when two DPI engines are available, a single bit may be used to determine the target DPI engine, one indicated by “0” and the other indicated by “1”. However, when four DPI engines are available, the steering characteristic may be adjusted to the last two bits of the symmetric hash, so that each of the four DPI engines may be represented, one indicated by “00”, a second indicated by “01, a third indicated by “10” and the fourth indicated by “11.”

As an example, the second steering engine 32 may perform a respective policy look-up 82 (e.g., policy look-up function) in a respective policy look-up table (e.g., stored at the second network switch 76) based on the symmetrical hash value. For example, the last bit of the symmetrical hash value may correspond to a target value associated with the target DPI engine in the respective policy look-up table. The respective policy look-up table may indicate that for entries with the last bit of the symmetrical hash value of 1 (e.g., target value of 1), the first network switch 74 and/or the second network switch 76 may be set to mirror the data packet to a remote mirror session via the private tunnel 24. The respective policy look-up table may also indicate that for entries with the last bit of the symmetrical hash value of 0 (e.g., target value of 0), the data packet may be transmitted to a local CPU (e.g., a dedicated, local CPU associated with the first network switch 74 or the second network switch 76). As an example, the last bit of 1 may be associated with an even session and the last bit of 0 may be associated with an odd session.

In the illustrated example of FIG. 3, the second steering engine 32 may perform the symmetric hashing on the first data packet and determine the last bit of the symmetrical hash value is 1. Thus, the second steering engine 32 may determine the steering characteristic 80 of the first data packet is the first steering characteristic, which is associated with the first network switch 74, indicating that the first network switch 74 is assigned to host DPI of the associated data packet. Therefore, the second network switch 76 may be set to mirror the first data packet to the remote mirror session via the private tunnel 24. That is, the second network switch 76 may identify that the first DPI engine 14 of the first network switch 74 is the target DPI engine to perform DPI on the first data packet. Therefore, the second network switch 76 may transmit the copy of the first data packet 84 to the first DPI engine 14 of the first network switch 74 via the private tunnel 24. As another example, the second steering engine 32 may identify a match of the steering characteristic to a value in the flow-lookup table of the second network switch 76 and identify the target DPI engine associated with the value in the flow-lookup table as the target DPI engine.

As described herein, performing DPI may involve both directions of network traffic transmitted between the first electronic device 20 and the second electronic device 22. Thus, in the illustrated example of FIG. 3, the second electronic device 22 may generate the second data packet flow 72 based on the first data packet flow 70. The second electronic device 22 may transmit a second data packet of the second data packet flow 72 to the first network switch 74 for transmission to the first electronic device 20. The first network switch 74 may determine that DPI is to be performed on the second data packet. Moreover, the first network switch 74 may generate a copy of the second data packet for DPI (e.g., based on the flow-miss or the attribute that indicates DPI is ongoing).

The first network switch 74 may employ the first steering engine 28 to determine a steering characteristic 86 (e.g., DPI steering characteristic) of the second data packet. It should be noted that the first steering engine 28 may determine the steering characteristic 86 in a similar manner described above with respect to the second steering engine 32. For example, the first steering engine 28 may also perform symmetric hashing of the second data packet and employ a respective policy look-up 88 in a respective policy look-up table (e.g., stored at the first network switch 74). The respective policy look-up table may indicate that for entries with the last bit of the symmetrical hash value of 1, the data packet may be transmitted to the local CPU. The respective policy look-up table may also indicate, for some packets, that for entries with the last bit of the symmetrical hash value of 0, the network switch may be set to mirror the data packet to the remote mirror session via the private tunnel 24.

It should be noted that the index provided by performance of the symmetric hash function may be the same for the first data packet and the second data packet, even if the header values of the first data packet and the second data packet are reversed. For example, the symmetrical hash value of the first data packet will be the same as the symmetrical hash value of the second data packet even if the source address, the destination address, the source port, and the destination port are reversed in each of the data packets. Moreover, it should be noted that similar routing may result if an additional network switch receives and processes data packets of the first data packet flow 70 and/or the second data packet flow 72 due to the ordering of the data packets and the resulting indices from symmetric hashing. Additionally, it should be noted that the symmetrical hash value for the first data packet (e.g., upstream data packet) and the second data packet (e.g., downstream data packet) may be a common hash value.

In this manner, symmetrically hashing the first data packet and the second data packet may ensure that the target DPI engine (e.g., the first DPI engine 14) is able to perform DPI. That is, the steering characteristic 80 of the first data packet may be symmetrical (e.g., common) with the steering characteristic 86 of the second data packet. Accordingly, the first steering engine 28 may steer a copy of the first data packet and the second steering engine 32 may steer a copy of the second data packet to the same target DPI, enabling DPI on both directions of the network traffic flow (e.g., the first data packet flow 70 and the second data packet flow 72).

In the illustrated example of FIG. 3, the first steering engine 28 may perform the symmetric hashing on the second data packet and determine the last bit of the symmetrical hash value is also 1. Thus, the first steering engine 28 may identify that the first DPI engine 14 (e.g., its own associated local CPU) is the target DPI engine to perform DPI on the second data packet. Therefore, the first network switch 74 may generate a copy of the second data packet 90 to provide the copy of the second data packet to the first DPI engine 14.

It should be noted that, at times, instead of symmetric hashing, the first steering engine 28 and the second steering engine 32 may load balance the network traffic based on a per-client basis (e.g., IP address), per-VLAN basis, or per-Virtual Routing and Forward (VRF) basis. Alternatively, the first steering engine 28 and the second steering engine 32 may perform a policy look-up based on attributes (e.g., instead of the symmetrical hash value) of the distribution of first data packet and the second data packet.

Additionally or alternatively, the first network switch 74 and the second network switch 76 may employ the private tunnel 24 to synchronize flow attributes. For example, the second DPI engine 18 may perform DPI on the one or more data packets and identify attributes associated with the one or more data packets. The policy look-up table may indicate that for an application associated with the one or more data packets (e.g., identified based on the flow attributes) is blocked. Therefore, the first network switch 74 and/or the second network switch 76 may drop the one or more data packets associated with the application to enable blocking the application.

However, to enable the first network switch 74 to identify that the application is blocked, the second network switch 76 may synchronize the flow attributes with the first network switch 74 via the private tunnel 24. That is, the second network switch 76 may provide the information in the policy look-up table that indicates that the application is blocked to enable synchronization between the first network switch 74 and the second network switch 76. It should be noted that the first network switch 74 and the second network switch 76 may perform synchronization of flow attributes continuously (e.g., on an ongoing basis, periodically, at regular intervals).

It should be noted that the techniques described herein with respect to FIG. 3 may continue for any number of data packets received and transmitted by the first electronic device 20 and the second electronic device 22. However, as the first network switch 74 and/or the second network switch 76 analyze the characteristics of the first data packet flow 70 and the second data packet flow 72, the first network switch 74 and/or the second network switch 76 may determine that enough data packets have been inspected to gather sufficient information. That is, the first network switch 74 and/or the second network switch 76 may have sufficient information regarding monitoring, security, and/or policy enforcement. Thus, the first network switch 74 and/or the second network switch 76 may determine that additional data packets are no longer useful (e.g., not to be used). Thus, the first network switch 74 and/or the second network switch 76 may cease steering any additional data packets to the target DPI engine in response to identifying that the additional data packets are no longer useful. It should also be noted that while the illustrated example provides network switches (e.g., the first network switch 74 and the second network switch 76), any suitable data forwarding components may be employed with the current techniques.

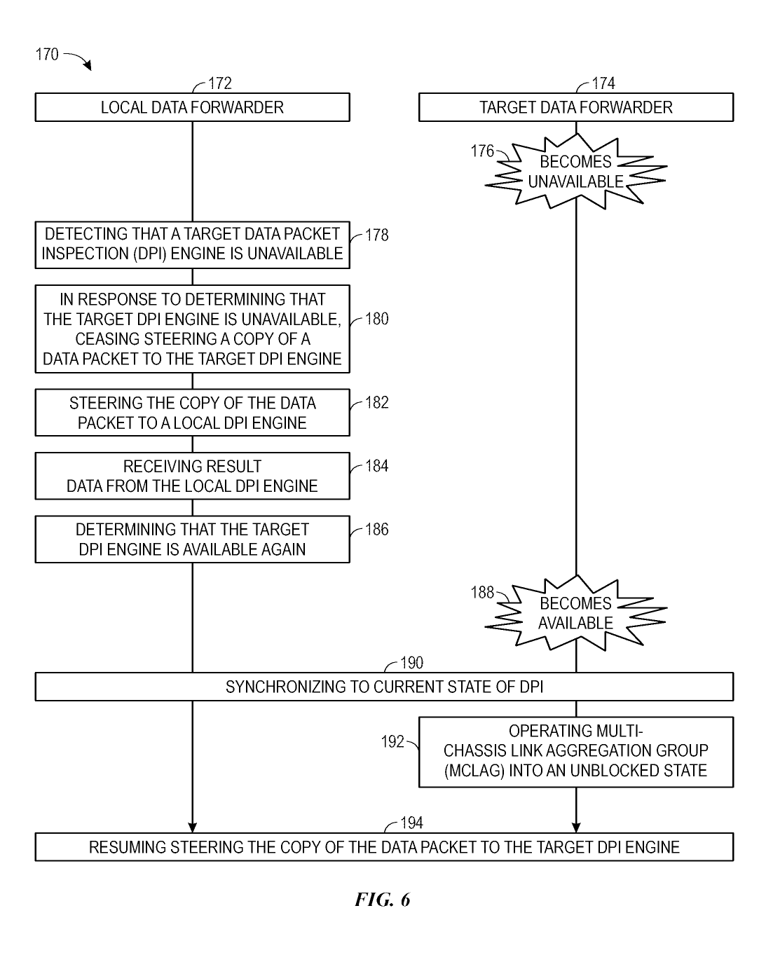

Further, as will be described in further detail below with respect to FIG. 6, if either the first network switch 74 or the second network switch 76 pauses operation, the other network switch may detect the paused operation. Further, the non-paused network switch (e.g., either the first network switch 74 or the second network switch 76) may suspend the policy, resulting in steering of the first data packet and the second data packet to the active DPI engine (e.g., of the non-paused switch). For example, if the first network switch 74 pauses operation, the second network switch 76 may detect the paused operation. The second network switch 76 may then suspend the policy, which may result in the steering of both the first data packet and the second data packet to the second DPI engine 18 of the second network switch 76.

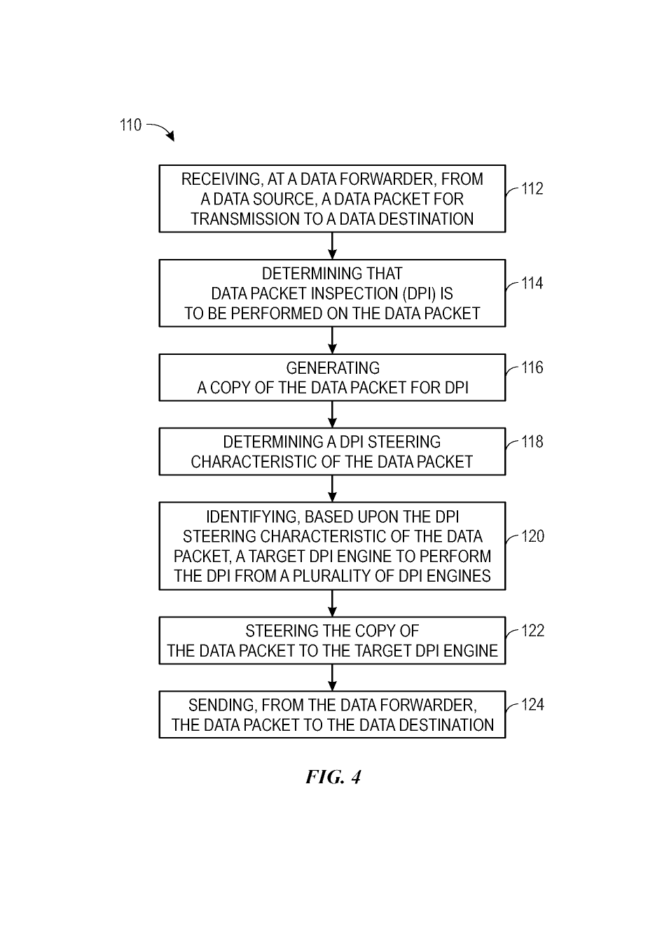

To elaborate on steering operations, FIG. 4 is a flowchart, illustrating a process 110 for steering a copy of a data packet to a target DPI engine, in accordance with aspect of the present disclosure. As described herein, the first data forwarder 12 (e.g., or the first network switch 74) and/or the second data forwarder 16 (e.g., or the second network switch 76) may steer respective one or more copies of data packets to a target DPI engine. Therefore, it should be noted that the first data forwarder 12 and/or the second data forwarder 16 may respectively perform the process 110 described herein.

The process 110 begins by receiving (e.g., at either the first data forwarder 12 or the second data forwarder 16), from a data source, a data packet for transmission to a data destination (block 112). For example, the data source may be the first electronic device 20 or the second electronic device 22. The data packet may be a respective packet of a network traffic. As another example, the data packet may be associated with a request to initiate an application (e.g., software application) and/or a request to access a database to read or write data relative to the database. The data packet may be received at an ingress port (e.g., of the first data forwarder 12 or the second data forwarder 16).

A determination is made as to whether DPI is to be performed on the data packet (block 114). For example, the determination may be based on a flow-miss in a flow-table lookup or a flow attribute indicating that DPI is ongoing, a traffic type, and/or a policy. The flow-miss may occur when a flow-table lookup is performed (e.g., by the first data forwarder 12 or the second data forwarder 16 that received the data packet) and the data packet does not match a flow entry in a flow-table during the lookup. The flow attribute indicating that DPI is ongoing may be associated with a flag or a marker in the flow entry in the flow-table that indicates that the data packet or a flow of the data packet is currently being inspected using DPI. Further, the traffic type may indicate that the data packet is associated with a portion or a role that has been set (e.g., in the one or more policies) by the system 10 for DPI.

In response to the determination that DPI is to be performed on the data packet, a copy of the data packet is generated (block 116). In this manner, a network traffic flow (e.g., including the data packet) may continue without interruption. For example, the network traffic flow may continue on with initiated routing without interruption. Indeed, the original data packet may be forwarded (e.g., based on the policy), while the copy of the data packet is retained for DPI. In this manner, the network traffic flow may continue while the DPI is performed on the copy of the data packet. Further, a determination is made as to a DPI steering characteristic of the data packet (block 118). The DPI steering characteristic may be determined based on identifying a symmetrical hash value of the data packet, employing a policy look-up table function, on a per-client basis, a per-VLAN basis, a per-VRF basis, and/or any other suitable load-distribution mechanism. On a per-client basis may be associated with a particular client (e.g., user, device, and/or endpoint). On a per-VLAN basis may be associated with the VLAN to which the network traffic belongs. On a per-VRF basis may be associated with isolated routing tables that enable multiple virtual networks to coexist on a same physical infrastructure. Thus, employing the policy look-up table function may be applied independently on each virtual network within the VRF.

For example, the symmetrical hash value may include a last bit of 0, which may be associated with a first steering characteristic, or a last bit of 1, which may be associated with a second steering characteristic. Further, the first steering characteristic may be associated with a first DPI engine (e.g., a DPI engine local to a first data forwarding component and remote to a second data forwarding component) and the second steering characteristic may be associated with a second DPI engine (e.g., a DPI engine local to the second data forwarding component and remote to the first data forwarding component).

Therefore, after the determination of the steering characteristic, a target DPI engine to perform DPI from a plurality of DPI engines is identified (block 120). For example, the steering characteristic may be determined to be the first steering characteristic. Thus, the first DPI engine 14 may be determined to be the target DPI engine. As another example, the steering characteristic may be determined to be the second steering characteristic. As such, the second DPI engine 18 may be determined to be the target DPI engine.

The copy of the data packet is steered to the target DPI engine (block 122). When the copy of the data packet is to be steered to a DPI engine local to the steering engine that received the data packet, the data packet may be steered via a local connection (e.g., private tunnel to the local DPI engine that enables transmission of the data packet) to the DPI engine. When the copy of the data packet is to be steered to a DPI engine remote to the steering engine that received the data packet, the data packet may be steered to the target DPI engine via the private tunnel 24. In this manner, the target DPI engine may perform DPI on the copy of the data packet. For example, the target DPI engine may analyze the contents of the data packet, such as the headers, to inspect the data packet. By analyzing the contents, it may be determined, for example, which application is being requested for connection in the data packet.

Further, the data packet may be sent to the data destination (block 124). For example, the data packet may be sent to the data destination via an egress port (e.g., of the first data forwarder 12 or the second data forwarder 16). Sending the data packet to the data destination may occur at an at least partially overlapping time frame as performing DPI (e.g., by the target DPI engine). In some cases, the data packet is held until DPI completes and, at which time, the data packet is sent to the data destination.

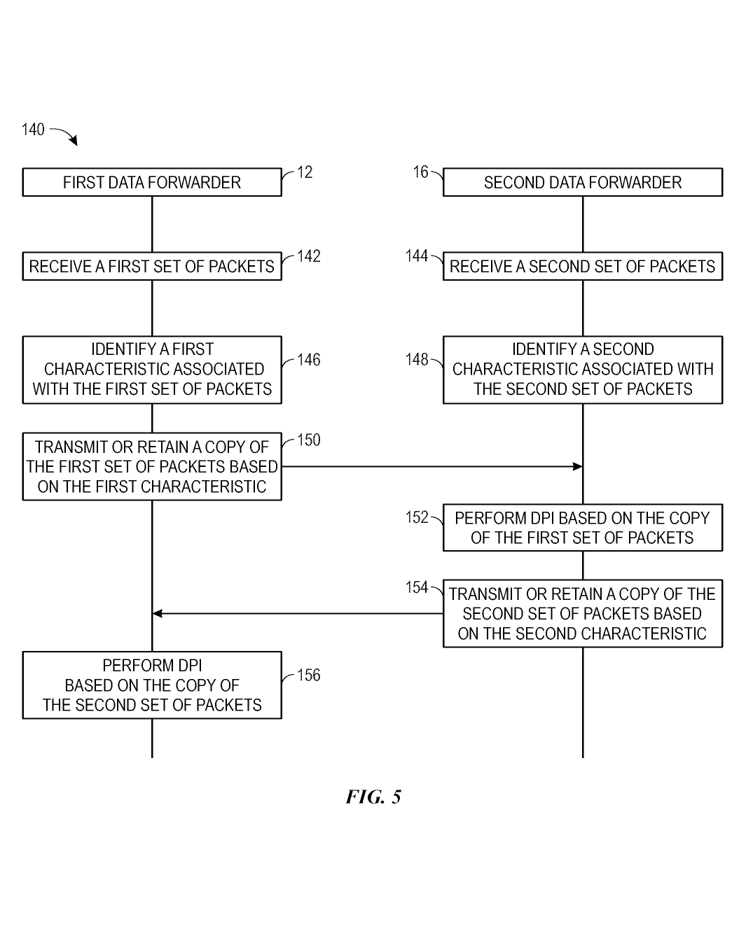

Operations of FIG. 4 may be implemented in a system with one or more forwarding devices (e.g., network switch), as an example. FIG. 5 illustrates operations of two data forwarder devices (e.g., first data forwarder 12 and second data forwarder 16) communicating copies of data packets to each other for DPI.

FIG. 5 is a flowchart, illustrating a process 140 for the first data forwarder 12 to steer a copy of a first set of data packets to the second data forwarder 16 for DPI, and the second data forwarder 16 to steer a copy of a second set of data packets to the first data forwarder 12 for DPI. As described herein, the first data forwarder 12 may include the first DPI engine 14 to perform DPI on one or more data packets received at the first data forwarder 12. Additionally, the second data forwarder 16 may include the second DPI engine 18 to perform DPI on one or more data packets received at the second data forwarder 16. First data forwarder 12 and second data forwarder 16 are used herein for illustrative purposes and it should be understood that similar operations may be performed by one or more other network devices, as described herein.

The first data forwarder 12 receives a first set of packets (e.g., first one or more packets) (block 142). For example, the first data forwarder 12 may receive the first set of packets from the first electronic device 20 of FIG. 1. The first data forwarder 12 may receive the first set of packets at an ingress port of the first data forwarder 12.

Moreover, the second data forwarder 16 receives a second set of packets (block 144). For example, the second data forwarder 16 may receive the second set of packets from the second electronic device 22 of FIG. 1. The second data forwarder 16 may receive the second set of packets at an ingress port of the second data forwarder 16.

The first data forwarder 12 identifies a first characteristic associated with the first set of packets (block 146). For example, the first data forwarder 12 may perform a symmetric hash of each of the first set of packets by hashing data from packet headers of each of the first set of packets to identify symmetrical hash values. The packet headers may include the source IP address, the destination IP address, the source port, the destination port, and the IP protocol (e.g., 5-tuple) of the first set of packets. As an example, the symmetrical hash values may include a last bit of 0 or a last bit of 1. Further, the symmetrical hash values may be identified as the first characteristic. The first data forwarder 12 may use the last bit of the symmetrical hash value (e.g., at block 150) as the first characteristic to determine whether to retain the copy of the data packet or to transfer the copy of the data packet to the second data forwarder 16.

Further, the second data forwarder 16 identifies a second characteristic associated with the second set of data packets (block 148). For example, the second data forwarder 16 may perform a symmetric hash of each of the second set of data packets by hashing data from the packet headers of each of the second set of data packets to identify symmetrical hash values. The symmetrical hash values may be identified as the second characteristic. The second data forwarder 16 may use the last bit of the symmetrical hash value (e.g., at block 154) as the second characteristic to determine whether to retain the copy of the data packet or to transfer the copy of the data packet to the first data forwarder 12.

To elaborate, first data forwarder 12 and the second data forwarder 16 may determine whether to retain or transmit a copy of a data packet to another data forwarder based on one or more policy indications. The first data forwarder 12 may reference an indication of a policy (e.g., software-based rules or instructions), which causes the first data forwarder 12 to steer copies of the first set of data packets having the first characteristic to the second DPI engine 18. Additionally, the second data forwarder 16 references an indication of a policy, which causes the second data forwarder 16 to steer copies of the second set of data packets having the second characteristic to the first engine.

Thus, the first data forwarder 12 transmits or retains a copy of the first set of packets to the second data forwarder 16 (e.g., via the private tunnel 24) based on the first characteristic (block 150). For example, the first characteristic may be associated with the first DPI engine 14 of the first data forwarder 12 (e.g., its own DPI engine) or the second DPI engine 18 of the second data forwarder 16 (e.g., remote DPI engine). If the first characteristic is associated with the first DPI engine 14 then the first data forwarder 12 may retrain the first set of packets. If the first characteristic is associated with the second DPI engine 18, then the first data forwarder 12 may transmit the copy of the first set of packets to the second data forwarder 16. The first data forwarder 12 may transmit the copy of the first set of data packets via a remote mirror tunnel established over the private tunnel 24. The private tunnel 24 may operate based on the inter-switch link 25. The private tunnel 24 may provide a private IP address space on an internal process for packet transportation.

The second data forwarder 16 performs DPI based on the copy of the first set of packets (block 152). The second data forwarder 16 may perform DPI by analyzing the contents of the first set of data packets. The second data forwarder 16 may analyze data and header contents of the first set of data packets to identify information associated with the first set of data packets. For example, the information may include an application type, a protocol, and/or security rules.

The second data forwarder 16 transmits or retains a copy of the second set of packets to the first data forwarder 12 (e.g., via the private tunnel 24) based on the second characteristic (block 154). For example, the second characteristic may be associated with the first DPI engine 14 of the first data forwarder 12 or the second DPI engine 18 of the second data forwarder 16. The second data forwarder 16 may transmit the copy of the second set of data packets via the remote mirror tunnel established over the private tunnel 24.

Accordingly, the first data forwarder 12 performs DPI based on the second set of data packets (block 156). For example, the first data forwarder 12 may perform DPI on retained DPI packets and/or DPI packets received from other data forwarders. The first data forwarder 12 may perform DPI based on analyzing the contents of the second set of data packets. The first data forwarder 12 may analyze data and header contents of the second set of data packets to identify information associated with the second set of data packets. For example, the information may include the application type, the protocol, and/or the security rules.

At times, the target DPI engine may become unavailable. For example, the target network data forwarder including the target DPI engine may pause operation, crash (e.g., experience failure or error), and/or power down. When this occurs, for example, the first steering engine 28 or the second steering engine 32 may cease steering the copy of the data packets to the first DPI engine 14 or the second DPI engine 18. With the foregoing in mind, FIG. 6 is a flowchart, illustrating the process 110 of FIG. 4 including a process 170 for ceasing steering a copy of a data packet based on the target DPI engine becoming unavailable. For purposes of discussion, the first data forwarder 12 may correspond to a local data forwarder 172 and the second data forwarder 16 may correspond to a target data forwarder 174. The local data forwarder 172 may be remote from the target data forwarder 174 and may communicate via the private tunnel 24.

The target DPI engine (e.g., the second DPI engine 18) of the target data forwarder 174 becomes unavailable (block 176). As described herein, the target data forwarder 174 may pause operation of the target DPI engine, crash, and/or power down.

Subsequently, the local data forwarder 172 detects that the target DPI engine is unavailable (block 178). For example, the local data forwarder 172 may receive periodic health indications (e.g., heartbeat signals, ping responses, status updates) from the target DPI engine that indicates that the target DPI engine is operational. However, if the local data forwarder 172 does not receive the indications within a threshold period of time, the local data forwarder 172 may determine the target DPI engine is unavailable. As another example, the local data forwarder 172 may periodically query the target DPI engine to check if the target DPI engine is available.

The local data forwarder 172 ceases steering the copy of the data packet to the target DPI engine in response to determining that the target DPI engine is unavailable (block 180). For example, the local data forwarder 172 may end (e.g., terminate) a remote-mirror session being performed via the private tunnel 24. As such, the local data forwarder 172 may redirect the copy of the data packet for DPI performance.

The local data forwarder 172 steers the copy of the data packet to a local DPI engine (e.g., associated with the local data forwarder 172) (block 182). As an example, the local data forwarder 172 may adjust a policy action for a first steering characteristic (e.g., associated with an even session flow) and a second steering characteristic (e.g., associated with an odd session flow) to be sent to a local CPU (e.g., associated with the local data forwarder) including the local DPI engine.

As such, the local data forwarder 172 receives the result data from the local DPI engine (block 184). For example, the result data may include resulting DPI analysis data associated with the copy of the data packet, such as an application type, a protocol, and/or security rules. The local data forwarder 172 may perform a computing operation based on the result data, such as permitting the network traffic flow to continue with routing, generating a report based on or including some or all of the result data and/or transmitting the report to another computing device to trigger an operation being performed by that computing device, or the like. The DPI analysis data may enable the local data forwarder 172 or downstream computing devices perform network administration operations, which may include permitting or denying access to the communication network connecting between network devices or the like.

The local data forwarder 172 determines that the target DPI engine is available again (block 186) as the target data forwarder 174 becomes available (block 188). For example, the local data forwarder 172 may receive an indication from the target data forwarder 174 indicating that the target data forwarder 174 is available again. As another example, the local data forwarder 172 may provide information associated with flow attributes to the target data forwarder 174 to enable flow attribute synchronization. Therefore, the local data forwarder 172 may determine the target data forwarder 174 is available based on being able to provide the information.

At block 190, the local data forwarder 172 and the target data forwarder 174 synchronize to a current state of DPI. That is, a current state of flows of the local data forwarder 172 is synchronized with the target data forwarder 174. By synchronizing the current state of flows of the local data forwarder 172 and the target data forwarder 174, flow-balancing may begin. The current state of DPI that is synchronized may be a subset of data packets assigned to the target DPI engine of the target data forwarder 174 as indicated by the first steering characteristic, the second steering characteristic, and/or a pre-outage policy (e.g., policy before the target data forwarder 174 becomes unavailable).

The target data forwarder 174 operates a multi-chassis link aggregation group (MCLAG) into an unblocked state (block 192). The MCLAG may include ports that terminate on separate chassis. The MCLAG may perform load balancing between its ports, such as between devices coupled to the respective ports. Indeed, when the target data forwarder 174 becomes unavailable (block 176), the target data forwarder 174 operates the MCLAG into a blocked state to disable active links, such as the private tunnel 24, with the target data forwarder 174. Once the target data forwarder 174 becomes available again, it may re-establish its connection and rejoin MCLAG, enabling the links to transition into the unblocked state. In this manner, communication on the network may remain stable and efficient even during switch failures or unavailability.

Accordingly, the local data forwarder 172 and the target data forwarder 174 resume steering the copy of the data packet to the target DPI engine (block 194). For example, the local data forwarder 172 and the target data forwarder 174 may employ the pre-outage policy to steer the copy of the data packet to the target DPI engine. In this manner, the target DPI engine may resume DPI, where the target DPI engine may be determined based on symmetric hashing operations described herein.

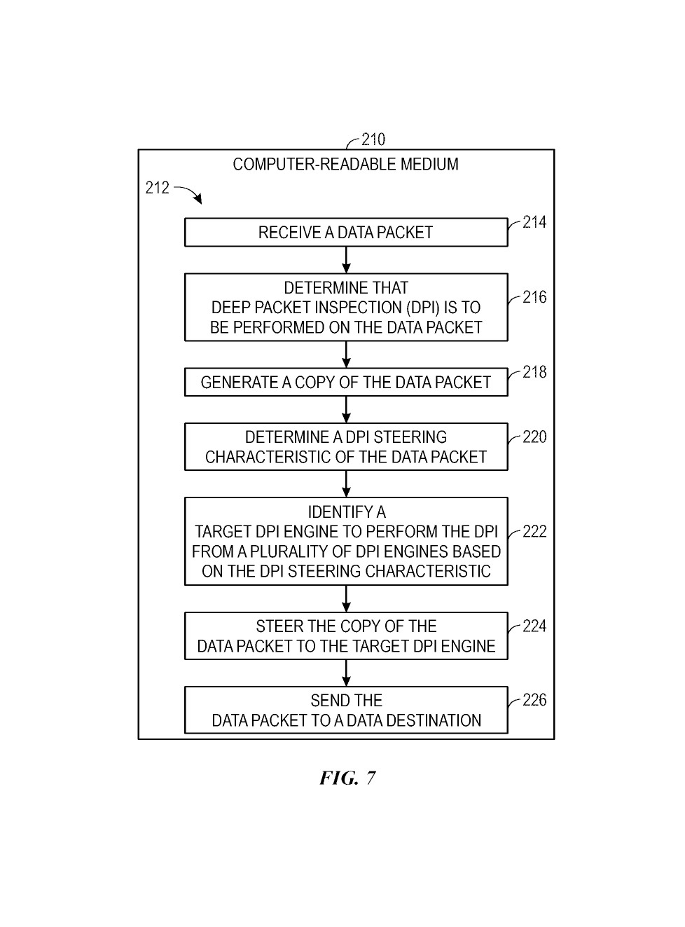

With the foregoing in mind, FIG. 7 is a diagram, illustrating a computer-readable medium 210 storing instructions to cause the system 10 to steer the copy of the data packet to the target DPI engine, in accordance with aspects of the present disclosure. The system 10 described herein may be any suitable computing device, such as a network device, a WLAN controller, a desktop computer, a laptop computer, a server, a web server, a mainframe, a tablet computer, an e-reader, a netbook computer, a mobile phone, a smartphone, a smart terminal, a dumb terminal, a virtual terminal, and so on. Indeed, the computer-readable medium 210 stores computer-readable instructions that, when executed by one or more processors (e.g., processors of the system 10) of one or more computers, cause the one or more computers to perform process 212 to cause steering of the copy of the data packet to the target DPI engine.

The one or more computers receive a data packet (block 214). For example, the one or more computers may receive the data packet from a data source, such as the first electronic device 20 of FIG. 1 or the second electronic device 22 of FIG. 1. The one or more computers may receive the data packet at an ingress port of the one or more computers. Further, the data packet may be a respective data packet of network traffic.

The one or more computers determine that DPI is to be performed on the data packet (block 216). For example, the one or more computers may identify DPI is to be performed based on a flow-miss (e.g., the data packet received does not match an existing entry) in a flow-table lookup. As another example, the one or more computers may determine that DPI is to be performed based on a flow attribute of the data packet that indicates that DPI is ongoing. As yet another example, the one or more computers may determine that DPI is to be performed based on a traffic type that indicates that the data packet is associated with a portion that has been set by the one or more computers for DPI.

The one or more computers generate a copy of the data packet (block 218). By generating a copy of the data packet, the network traffic flow, including the data packet, may continue without interruption. For example, the original data packet may be forwarded to an additional electronic device with initiated routing without interruption. At a same or similar time, the copy of the data packet is retained for DPI. The one or more computers determine a DPI steering characteristic of the data packet (block 220). For example, the one or more computers may determine the DPI steering characteristic by identifying a symmetrical hash value of the data packet. The one or more computers may employ a policy look-up table function to determine the DPI steering characteristic. The one or more computers may employ the policy look-up table function on a per-client basis, per-VLAN basis, per-VRF basis, and so on.

After determining the DPI steering characteristic, the one or more computers identify the target DPI engine to perform DPI of the plurality of DPI engines (block 222). For example, the DPI steering characteristic may be a first DPI steering characteristic or a second DPI steering characteristic, derived based upon a symmetric hash or other common attribute value between forward and backward data packet transmissions between a source electronic device and a destination electronic device. As mentioned above, in some cases, the symmetric hash may include a 5-tuple for the data packets that is common in packets flowing from source to destination and packets flowing from destination to source. The steering characteristic may be a last number of bits that may identify a particular one of plurality of DPI engines to host DPI for the packet. If the DPI steering characteristic is the first steering characteristic, the one or more computers may identify the first DPI engine 14 as the target DPI engine. If the DPI steering characteristic is the second steering characteristic, the one or more computers may identify the second DPI engine 18 as the target DPI engine.

Thus, the one or more computers steer the copy of the data packet to the target DPI engine (block 224). As such, the target DPI engine may perform DPI on the copy of the data packet. The target DPI engine may analyze data and header contents of the copy of the data packet. For example, the target DPI engine may identify information associated with an application type, a protocol, and/or security rules.

Further, the one or more computers send the data packet to the data destination (block 226). It should be noted that the one or more computers may send the data packet to the data destination at an at least partially overlapping time frame as performing DPI. At times, the one or more computers may hold the data packet until DPI completes and, at which time, the data packet is sent to the data destination.

The techniques described herein enable data forwarders, such as network switches, to identify a local CPU with a local DPI engine or a remote CPU with a remote DPI engine to route network traffic to via a network link. That is, the data forwarders may employ an infrastructure of a system within a network to route the data packets for DPI, which may reduce or minimize disruption of existing network traffic. Moreover, by employing dedicated CPUs, such as the local CPU or the remote CPU, the techniques described herein may enable scalability without involving additional usage of computing resources. Indeed, the data forwarders may offload DPI operations to the local CPU or the remote CPU, which may reduce usage of computing resources. Further, the data forwarders may dynamically adjust network traffic routes between the local CPU, the remote CPU, or any other suitable CPU, to load balance. Since DPI is performed on copies of the network traffic, DPI may be performed without interrupting or negating load balancing operations. Indeed, techniques described herein enable DPI operations without constraining routing with the network switch arrangements, which may increase efficiency of the system.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A network device, configured to:
receive, from a data source, a data packet for transmission to a data destination;
determine that deep packet inspection (DPI) is to be performed on the data packet;
generate a copy of the data packet;
determine a DPI steering characteristic of the data packet;
identify, based upon the DPI steering characteristic of the data packet, a target DPI engine to perform the DPI from a plurality of DPI engines, wherein the target DPI engine is remote from the network device and coupled to an additional network device;
steer the copy of the data packet to the target DPI engine; and
send the data packet to the data destination.

2. The network device of claim 1, configured to identify the target DPI engine by:
identifying a match of the DPI steering characteristic to a value in a flow-lookup table of the network device; and
identifying a DPI engine associated with the value in the flow-lookup table as the target DPI engine.

3. The network device of claim 1, configured to determine the DPI steering characteristic of the data packet by identifying a symmetrical hash associated with the data packet.

4. The network device of claim 3, wherein the symmetrical hash comprises a common hash value for both upstream data packets and downstream data packets.

5. The network device of claim 3, wherein the symmetrical hash comprises a 0 as a last bit or a 1 as the last bit, the 0 indicating a first target DPI engine and the 1 indicating a second target DPI engine.

6. The network device of claim 3, wherein the symmetric hash comprises a hashing of data from a packet header of the data packet.

7. The network device of claim 1, configured to steer the copy of the data packet to the target DPI engine by transmitting the copy of the data packet to the additional network device via a remote mirror tunnel established over a network link between the network device and the additional network device.

8. The network device of claim 1, wherein the DPI steering characteristics comprises a bit value of at least a portion of a symmetrical hash of a 5-tuple associated with the data packet.

9. The network device of claim 1, configured to:
identify that an additional data packet is not to be used for DPI; and
cease steering the additional data packet to the target DPI engine in response to identifying that the additional data packet is not to be used for DPI.

10. A method comprising:
receiving a data packet for transmission to a data destination;
determining that deep packet inspection (DPI) is to be performed on the data packet;
generating a copy of the data packet;
determining a DPI steering characteristic of the data packet;
identifying, based upon the DPI steering characteristic of the data packet, a target DPI engine to perform the DPI from a plurality of DPI engines;
steering the copy of the data packet to the target DPI engine; and
sending the data packet to the data destination.

11. The method of claim 10, wherein the DPI steering characteristic of the data packet comprises a symmetrical characteristic that is common between the data packet and a subsequent data packet received from the data destination for transmission to a data source.

12. The method of claim 10, comprising determining the DPI steering characteristic, by:
extracting metadata from the data packet;
generating a hash from the metadata; and
determining the DPI steering characteristic from the hash.

13. The method of claim 12, wherein the hash comprises a symmetrical hash and the DPI steering characteristic comprises a value of a subset of bits of the symmetrical hash.

14. The method of claim 10, comprising identifying the target DPI engine, by:
identifying a match between the DPI steering characteristic and a target value associated with the target DPI engine based on a policy look-up table.

15. The method of claim 10, comprising:
determining that the target DPI engine is unavailable; and
cease steering the copy of the data packet to the target DPI engine in response to determining that the target DPI engine is unavailable.

16. The method of claim 15, comprising:
after determining that the target DPI engine is unavailable, determining that the target DPI engine is available again; and
in response to determining that the target DPI engine is available again:
synchronizing a current state of DPI; and
after synchronizing, resume steering the copy of the data packet to the target DPI engine.

17. One or more tangible, non-transitory computer-readable media storing instructions that, when executed by processing circuitry, are configured to cause the processing circuitry to:
receive a data packet for transmission to a data destination;
determine that deep packet inspection (DPI) is to be performed on the data packet;
generate a copy of the data packet;
determine a DPI steering characteristic of the data packet;
identify, based upon the DPI steering characteristic of the data packet, a target DPI engine to perform the DPI from a plurality of DPI engines;
steer the copy of the data packet to the target DPI engine; and
send the data packet to the data destination.

18. The one or more tangible, non-transitory computer-readable media of claim 17, wherein the instructions, when executed by the processing circuitry, are configured to cause the processing circuitry to, steer the copy of the data packet to the target DPI engine by transmitting the copy of the data packet to a network device via a network link.

19. The one or more tangible, non-transitory computer-readable media of claim 18, wherein the instructions, when executed by the processing circuitry, are configured to cause the processing circuitry to steer the data packet based on a policy.

20. The one or more tangible, non-transitory computer-readable media of claim 19, wherein the instructions, when executed by the processing circuitry, are configured to cause the processing circuitry to:
detect that the network device has paused operation; and
suspend the policy to cause steering of the data packet to an additional network device in response to detecting the paused operation.
